(19) United States
(12) Patent Application Publication
(10) Pub. No.: US 2014/0185317 A1
(43) Pub. Date: Jul. 3, 2014

(54) BACK LIGHT UNIT AND IMAGE DISPLAY DEVICE USING THE SAME

(71) Applicant: Kabushiki Kaisha Toshiba, Tokyo (JP)

(72) Inventors: Harumi Tanabe, Hamura-shi (JP); Yoshihiro Morito, Fukaya-shi (JP); Hisayuki Mihara, Kodama-gun (JP); Hirofumi Sakurai, Kumagaya-shi (JP)

(73) Assignee: Kabushiki Kaisha Toshiba, Tokyo (JP)

(21) Appl. No.: 14/065,282

(22) Filed: Oct. 28, 2013

Related U.S. Application Data
(63) Continuation of application No. PCT/JP2013/059046, filed on Mar. 27, 2013.

(30) Foreign Application Priority Data
Dec. 27, 2012 (JP) 2012-286149

(51) Int. Cl. F21V 8/00

(52) U.S. Cl. CPC G02B 6/0058
USPC 362/607

(57) ABSTRACT

According to one embodiment, an edge light-type back light unit includes, a light source, a light guide plate and a light quantity controller. The light source configured to exit light. The light guide plate includes a lens configured to prevent diffusion of the light exiting the light source and being incident onto a portion other than a portion corresponding to a vicinity of a boundary between the center portion and the periphery portion of the image display screen and a light diffuser of the light guide plate configured to diffuse light exiting the light source and being incident onto the portion corresponding to the vicinity of the border between the center portion and the periphery portion of the image display screen.

### CROSS-REFERENCE TO RELATED APPLICATIONS

This application is a Continuation Application of PCT Application No. PCT/JP2013/059046, filed Mar. 27, 2013 and based upon and claiming the benefit of priority from Japanese Patent Application No. 2012-286149, filed Dec. 27, 2012, the entire contents of all of which are incorporated herein by reference.

### FIELD

Embodiments described herein relate generally to an edge light-type back light unit and an image display device using the same.

### BACKGROUND

As well known, an image display device using a liquid crystal display panel for display of an image is adopted now. In the image display device, a back light is installed at the back of the liquid crystal display panel which controls an amount of transmission of light for every pixel, and an image is reproduced by causing illumination light from the back light to transmit through the liquid crystal display panel.

Thus, this kind of image display device can be configured as a compact and lightweight device compared with an image display device using a CRT (cathode ray tube). Especially, a large screen can be easily obtained, and such an advantage becomes the factor of dissemination of a large-screen digital television set serving as a broadcast receiver like the present.

On the other hand, since the back light of the image display device uses, for example, a cold cathode tube, such as a fluorescence tube or and an electric discharge as a light source, there are disadvantages that high driving power is needed and a lifespan is short. Therefore, as the light source of the back light, currently, a white LED (light emitting diode) is used because of low voltage drive and long-lasting durability.

This kind of image display device is considered to use an edge light-type back light having a structure in which a plurality of LEDs are arrayed along an end face of a liquid crystal display panel, and exit light emitted from each LED is uniformly emitted to the back surface of the liquid crystal panel via a light guide plate, and enables the image display device to become thinner.

However, the image display device using the edge light-type back light is just a developing device, and there is much room for improvement in various aspects for practical use. Especially, it is important to reduce the number, driving power, or the like of LEDs constituting the back light in order to save energy.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a side view illustrated to describe an outline of an example of a liquid crystal display device according to an embodiment;

FIG. 2 is a front view illustrated to describe an example of a back light unit which constitutes the liquid crystal display device according to an embodiment;

FIG. 3 is a top view illustrated to describe an example of an LED bar which constitutes the back light unit according to an embodiment;

FIG. 4 is a front view illustrated to describe an example of a light guide plate which constitutes the back light unit according to an embodiment;

FIG. 5 is a diagram illustrated to describe an example of a shape of a lens formed in the light guide plate according to an embodiment;

FIG. 6 is a diagram illustrated to describe an example of a main configuration of a lens formed in the light guide plate according to an embodiment;

FIG. 7 is a diagram illustrated to describe another example of the main configuration of the lens formed in the light guide plate according to an embodiment;

FIG. 8 is a diagram illustrated to describe a further example of the main configuration of the lens formed in the light guide plate according to an embodiment;

FIG. 9 is diagram illustrated to describe a modification of the shape of the lens formed in the light guide plate according to an embodiment;

FIG. 10 is a plan view illustrated to describe another example of the LED bar which constitutes the back light unit according to an embodiment; and

FIG. 11 is a plan view illustrated to describe a further example of the LED bar which constitutes the back light unit according to an embodiment.

### DETAILED DESCRIPTION

Various embodiments will be described hereinafter with reference to the accompanying drawings.

In general, according to one embodiment, an edge light-type back light unit comprises: a light source, a light guide plate and a light quantity controller. The light source configured to exit light. The light guide plate includes a lens configured to prevent diffusion of the light exiting the light source and being incident onto a portion other than a portion corresponding to a vicinity of a boundary between the center portion and the periphery portion of the image display screen and a light diffuser of the light guide plate configured to diffuse light exiting the light source and being incident onto the portion corresponding to the vicinity of the border between the center portion and the periphery portion of the image display screen. The light quantity controller configured to set a quantity of light emitted to a portion of the liquid crystal display panel which corresponds to a center portion of an image display screen to be larger than a quantity of light emitted to a portion of the liquid crystal display panel which corresponds to a periphery portion of the image display screen.

Embodiments will now be described hereinafter in detail with reference to the accompanying drawings.

According to one embodiment, a back light unit applies to an edge light-type back light unit configured to cause exit light from a light source to be emitted to a back surface of a liquid crystal display panel via a light guide plate.

The back light unit further comprises a light quantity controller configured to set a quantity of light emitted to a portion of the liquid crystal display panel which corresponds to a center portion of an image display screen to be larger than a quantity of light emitted to a portion of the liquid crystal display panel which corresponds to a periphery portion of the image display screen. The light guide plate comprises a lens for preventing diffusion of light exiting the light source and being incident onto a portion other than a portion corresponding to a vicinity of a boundary between the center portion and the periphery portion of the image display screen, and a light diffuser for diffusing light exiting the light source and being incident onto the portion corresponding to the vicinity of the boundary between the center portion and the periphery portion of the image display screen.

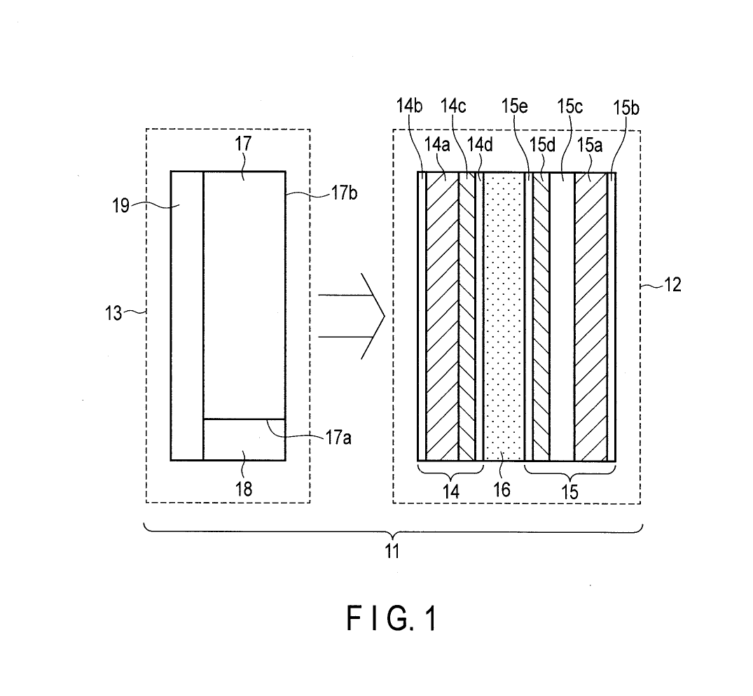

FIG. 1 schematically illustrates an example of a liquid crystal display 11 as an image display device described in the present embodiment. The liquid crystal display 11 comprises a liquid crystal display panel 12 which controls an amount of transmission of light for every pixel, and a back light unit 13 which illuminates a back surface of the liquid crystal display panel 12 with illumination light.

Among these, in the liquid crystal display panel 12, a substrate module 14 to serve as a pixel driving side, and a substrate module 15 to serve as a counter electrode side are arranged to face each other and spaced a predetermined length apart. In the structure, a liquid crystal layer 16 in which liquid crystals are sealed is formed between the substrate module 14 and the substrate module 15.

The substrate module 14 to serve as the pixel driving side comprises a glass substrate 14a facing the liquid crystal layer 16. A polarizing plate 14b is stacked on a surface of the glass substrate 14a which is opposite to the liquid crystal layer 16. On the other surface of the glass substrate 14a, a transparent conductive film 14c, in which pixel electrodes and driving thin film transistors are formed, and an aligning film 14d are successively stacked.

The substrate module 15 to serve as the counter electrode side also comprises a glass substrate 15a facing the liquid crystal layer 16. A polarizing plate 15b is stacked on a surface of the glass substrate 15a which is opposite to the liquid crystal layer 16. On the other surface of the glass substrate 15a, a color filter 15c, a transparent conductive film 15d, in which counter electrodes are formed, and an aligning film 15e are successively stacked.

The back light unit 13 has an edge light-type structure, and is provided with a light guide plate 17 facing the back surface of the liquid crystal display panel 12. A light source unit 18 is installed in an end portion (for example, a lower end portion in FIG. 1) of the light guide plate 17, and a light reflector 19 is installed in a surface of the light guide plate 17 which faces the liquid crystal display panel 12.

The back light unit 13 illuminates the lower end portion (light incident surface 17a) of the light guide plate 17 with exit light from the light source unit 18. The exit light from the light source unit 18 enters into the light guide plate 17, and then is emitted from a surface (light exit surface 17b) where the light reflector 19 is not installed. For this reason, the back light unit 13 can illuminate the whole back surface of the liquid crystal display panel 12 with light.

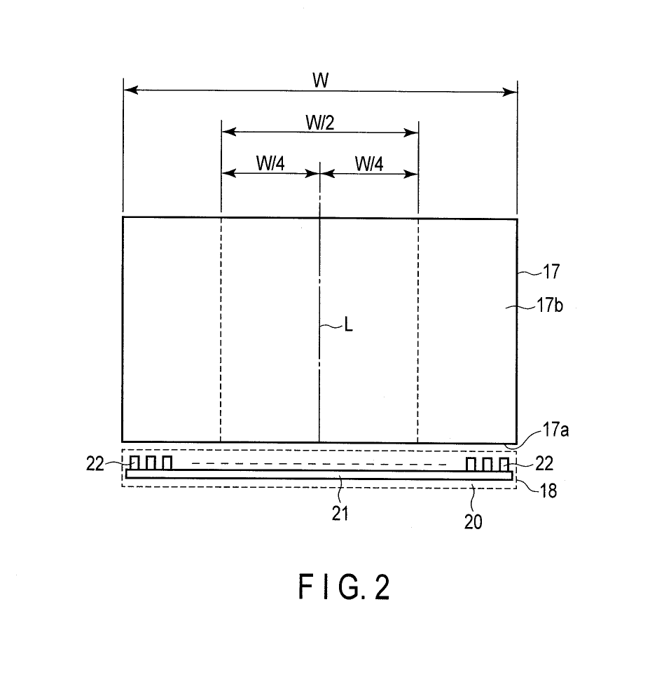

FIG. 2 illustrates an example of a state of the light guide plate 17 and light source unit 18 from the perspective of a light exit surface, i.e., the liquid crystal display panel 12. That is, the light guide plate 17 has the light exit surface 17b having substantially the same size as an effective display screen of the liquid crystal display panel 12, i.e., the same size as a substantial image display screen of the liquid crystal display 11.

The light source unit 18 further comprises an LED bar 20 installed along the light incident surface 17a of the light guide plate 17. This LED bar 20 comprises a belt-like printed circuit board 21 installed along the light incident surface 17a of the light guide plate 17, and a plurality of LEDs 22, 22, . . . which are connected to one another and arranged at a predetermined interval along a longitudinal direction on the printed circuit board 21. The plurality of LEDs 22, 22, . . . are white LEDs, for example.

The exit light from each LED 22, 22, . . . , is incident onto the light incident surface 17a of the light guide plate 17 when the plurality of LEDs 22, 22, . . . are driven by flowing current. By this, the light incident onto the light guide plate 17 is emitted to the back surface of the liquid crystal display panel 12 from the light exit surface 17b.

In the liquid crystal display 11, luminosity (brightness) of a center portion of the image display screen is set to be higher than that of a screen periphery portion. This setting improves the brightness of a displayed image felt by a viewer of the screen.

That is, by increasing the luminosity of the center portion of the image display screen, it is possible to make a viewer feel that a displayed image is brighter, without increasing the luminosity of the whole screen high, i.e., without having to increase the luminosity of the screen periphery portion. This leads to a reduction in the number and/or driving power of the LEDs 22, 22, . . . used as the light source.

How much the luminosity of the center portion of the image display screen is higher than the luminosity of the screen periphery portion, that is, how much is a difference in the luminosity between the center portion and the screen periphery portion of the image display screen may be set to a range in which a viewer may not feel unnaturalness for the brightness of the screen.

In order to set the luminosity of the center portion of the image display screen to be higher than the luminosity of the screen periphery portion of the image display screen, a light quantity of the LEDs 22, 22, . . . which emit light to the center portion of the image display screen among the plurality of LEDs 22, 22, . . . , which constitute the LED bar 20 is set to be larger than a light quantity of the LEDs 22, 22, . . . , which emit light to the periphery portion of the image display screen.

In this case, the center portion of the image display screen which should have higher luminosity is considered to be within such a range in a horizontal direction that a total horizontal length of the range is not longer than W/2, that is, a length from a left end or a right end of the range to a center line L, dividing the light guide plate 17 in half into a left portion and a right portion, is W/4 at most when a horizontal length of the light guide plate 17 (corresponds to the size of the image display screen) is set to W. The screen periphery portion is considered to be outside the range of the center portion of the image display screen.

In addition, as for both “within the range” (the center portion of the image display screen) and “outside the range” (the screen periphery portion), the luminosity in a vertical direction is set to be uniform. That is, the center portion and the screen periphery portion of the image display screen are specified only in terms of the range in the horizontal direction of the screen, and are not specified in terms of the range in the vertical direction of the screen.

As described above, by setting the luminosity of the center portion in terms of the horizontal direction within the image display screen to be higher than the luminosity of the other portion, it is possible to make a viewer feel that a displayed image is bright, without having to increase the luminosity of the whole screen.

That is, when the center portion of the image display screen is set to be within the range with a horizontal length of W/2 at most which is disposed in the center of the light guide plate 17, and when the luminosity of the range is set to be higher than the luminosity of the screen periphery portion, the effect of enabling a viewer to feel that a displayed image is bright can be obtained although the luminosity of the screen periphery portion is not increased.

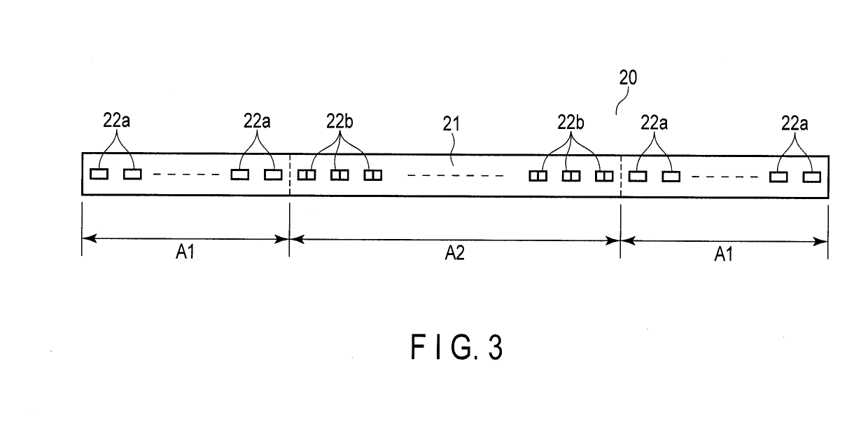

FIG. 3 illustrates an example of a unit configured to set a light quantity of the LEDs 22, 22, . . . which emit light to the center portion of the image display screen among the plurality of LEDs 22, 22, . . . which constitute the LED bar 20 to be larger than a light quantity of the LEDs 22, 22, . . . which emit light to the periphery portion of the image display screen.

That is, in the LED bar 20 illustrated in FIG. 3, the LEDs 22, 22, . . . which emit light to the periphery portion of the image display screen, i.e., the LEDs 22, 22, . . . arranged in regions A1 and A1 disposed at both end portions corresponding to the periphery portion of the image display screen are typical single chip LEDs 22a, 22a, . . . where an LED chip is accommodated in an LED casing.

On the other hand, in the LED bar 20 illustrated in FIG. 3, the LEDs 22, 22, . . . which emit light to the center portion of the image display screen, i.e., the LEDs 22, 22, . . . arranged in a region A2 corresponding to the center portion of the image display screen are dual chip LEDs 22b, 22b, . . . where two LED chips are accommodated in an LED casing. In this way, a quantity of illumination light for the center portion of the image display screen is set to be larger than a quantity of illumination light for the screen periphery portion.

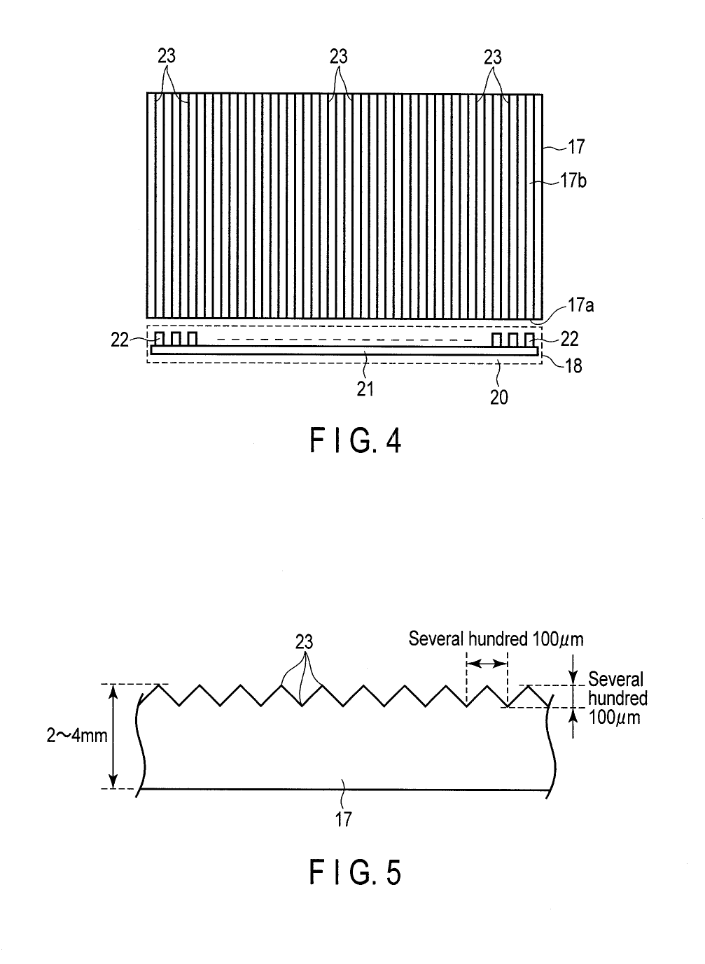

Here, as illustrated in FIG. 4, lenses 23 are installed in the light exit surface 17b of the light guide plate 17, along a longitudinal direction of the LED bar 20 constituting the light source unit 18, i.e., a direction orthogonally intersecting a direction in which the plurality of LEDs 22, 22, . . . are arranged. As illustrated in the example of FIG. 5, the lenses 23 are formed an inversed V shape of a convex shape (or a V shape of a concave shape) and are repeatedly formed in the light exit surface 17b of the light guide plate 17, along the horizontal direction of the image display screen.

Both of a repeat pitch of the lenses 23 in the horizontal direction of the light guide plate 17, and a vertical height from the top to bottom of each lens 23 are in order of several 100 μm, and a thickness of the light guide plate 17 including a thickness of the lens 23 is set to about 2 to 4 mm.

That is, because of the lenses 23 formed in the light exit surface 17b of the light guide plate 17 and formed to extend in the direction orthogonally intersecting the direction in which the plurality of LEDs 22, 22, . . . are arranged, i.e., a direction corresponding to a perpendicular direction to the image display screen, the light which exits the light source unit 18 and is incident onto the light guide plate 17 is efficiently guided along the direction corresponding to the perpendicular direction to the image display screen in the light guide plate 17, without being wastefully diffused. Thus, the light which is incident onto the light guide plate 17 is uniformly emitted to the back surface of the liquid crystal display panel 12 from the light exit surface 17b.

However, when the lenses 23 are formed in the light exit surface 17b of the light guide plate 17, and the light being incident onto the light incident surface 17a of the light guide plate 17 is guided up to the vicinity of the opposite end side of the light guide plate 17, if the quantity of the illumination light for the center portion of the image display screen is set to be larger than the quantity of the illumination light for the screen periphery portion as described above, a difference in the luminosity becomes easy to be conspicuous at the boundary between the center portion and the screen periphery portion of the image display screen, which makes a viewer feel unnaturalness.

So, in this embodiment, for a portion of the light exit surface 17b of the light guide plate 17 which corresponds to the vicinity of the boundary between the center portion and the screen periphery portion of the image display screen, the shape of the lens 23 is designed such that the light being incident onto the light guide plate 17 is diffused and easily mixed together. When this structure is adopted, even when the luminosity of the center portion of the image display screen is set to be higher than that of the screen periphery portion, i.e. when a quantity of light being incident onto a portion of the light guide plate 17 which corresponds to the center portion of the image display screen is set to be larger than a quantity of light being incident onto a portion of the light guide plate 17 which corresponds to the screen periphery portion, since the light being incident on both sides is diffused and mixed in the vicinity of the boundary between the center portion and the periphery portion of the image display screen in the light guide plate 17, the difference in the luminosity in the boundary between the center portion and the periphery portion of the image display screen becomes inconspicuous. Because of this, an image can be displayed with luminosity at which a viewer does not feel unnaturalness throughout the whole screen.

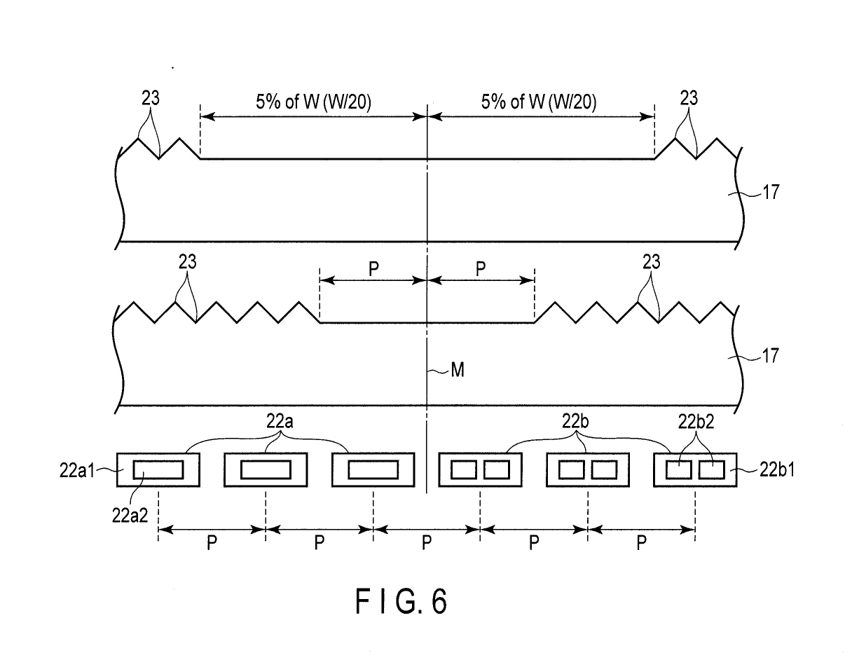

FIG. 6 illustrates an example of the shape of the lens 23 formed in the portion corresponding to the vicinity of the boundary between the center portion and the screen periphery portion of the image display screen within the light exit surface 17b of the light guide plate 17. That is, as described above, the LEDs 22, 22, . . . includes single chip LEDs 22a, 22a, . . . where an LED chip 22a2 is accommodated in an LED casing 22a1, and dual chip LEDs 22b, 22b, . . . where two LED chips 22b2 and 22b2 are accommodated in an LED casing 22b1.

All of the LEDs 22, 22, . . . are arranged with the same pitch P on the printed circuit board 21, regardless of the single chip LEDs 22a, 22a, . . . and the dual chip LEDs 22b, 22b, . . . . That is, the pitch of the single chip LEDs 22a and 22a adjoining each other, the pitch of the dual chip LEDs 22b and 22b adjoining each other, and the pitch of the single chip LED 22a and the dual chip LED 22b adjoining each other are all set to the same pitch P.

Here, as for the portion corresponding to the vicinity of the boundary between the center portion and the screen periphery portion of the image display screen, i.e., the portion corresponding to a position where the single chip LED 22a and the dual chip LED 22b adjoin each other within the light exit surface 17b of the light guide plate 17, the repeat pitch of the lens 23 is set to be larger than that for any other portions. In other words, the lens 23 may not be formed in the concerned portion of the light exit surface 17b of the light guide plate 17.

Thus, when the lens 23 does not exist in the portion corresponding to the position where the single chip LED 22a and the dual chip LED 22b adjoin each other within the light exit surface 17b of the light guide plate 17, since the exit light from the single chip LED22a and the exit light from the dual chip LED 22b are diffused within the light guide plate 17 and become easy to be mixed, the difference in the luminosity in the boundary between the center portion and the screen periphery portion of the image display screen becomes inconspicuous. Thus, such an image display that a viewer does not feel unnaturalness throughout the whole screen is performed.

In this case, the range of the portion, in which the lens 23 does not exist, within the light exit surface 17b of the light guide plate 17 is assumed to be 5% (W/20) of the horizontal length W of the light guide plate 17 at most and the installation pitch P of the LEDs 22, 22, . . . at least in each of left and right sides from a central line M which orthogonally intersects the direction in which the LEDs 22, 22, . . . are arranged and which divides the pitch P between the single chip LED 22a and the dual chip LED 22b in half into a left portion and a right portion.

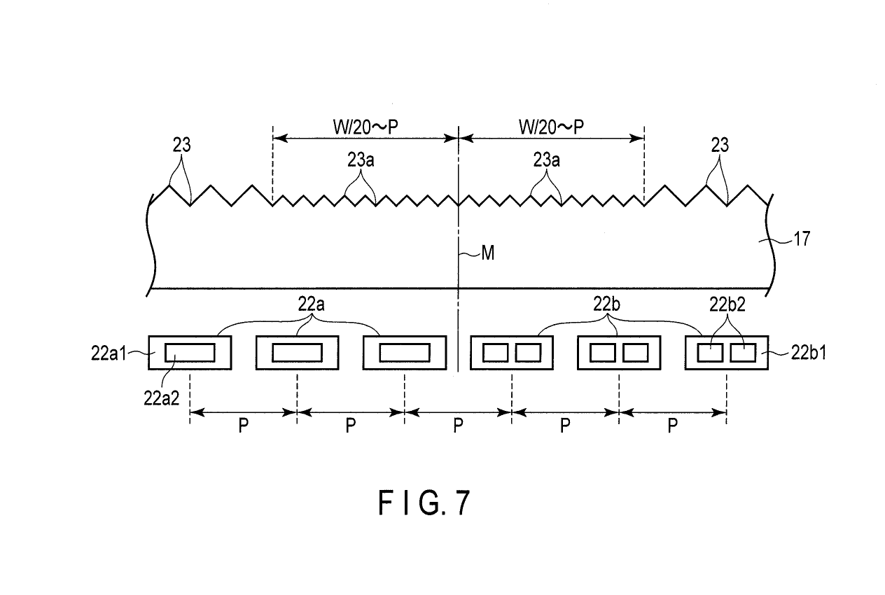

FIG. 7 illustrates another example of the shape of the lens 23 formed in the portion corresponding to the vicinity of the boundary between the center portion and the screen periphery portion of the image display screen within the light exit surface 17b of the light guide plate 17. That is, in the portion corresponding to the vicinity of the boundary between the center portion and the screen periphery portion of the image display screen within the light exit surface 17b of the light guide plate 17, i.e., the portion corresponding to the position where the single chip LED 22a and the dual chip LED 22b adjoin, a lens 23a is formed to have a longer repeat pitch and a smaller vertical height from top to bottom than the lenses 23 formed in any other portions.

Even with the structure in which the lens 23a with a longer repeat pitch and a smaller vertical height from top to bottom than any other portions is formed in the portion corresponding to the position where the single chip LED 22a and the dual chip LED 22b adjoin within the light exit surface 17b of the light guide plate 17, the exit light from the single chip LED 22a and the exit light from the dual chip LED 22b become easy to be diffused and mixed each other within the light guide plate 17 compared with other lenses 23. Since, the difference in the luminosity in the boundary between the center portion and the screen periphery portion of the image display screen becomes inconspicuous. Thus, such an image display that a viewer may not feel unnaturalness throughout the whole screen is performed.

In this case, the range of the portion, in which the lens 23a with a longer repeat pitch and a smaller vertical height from top to bottom than any other portions is formed, within the light exit surface 17b of the light guide plate 17 is considered to be 5% (W/20) of the horizontal length W of the light guide plate 17 at most and to be the installation pitch P of the LEDs 22, 22, . . . at least in each of left and right sides of a central line M which orthogonally intersects the direction in which the LEDs 22, 22, . . . are arranged and divides the pitch P between the single chip LED 22a and the dual chip LED 22b in half into a left portion and a right portion as described above.

The lens 23a formed in the portion corresponding to the position where the single chip LED 22a and the dual chip LED 22b adjoin within the light exit surface 17b of the light guide plate 17 may be either increased in the repeat pitch or decreased in the vertical height compared with the lenses 23 formed in any other portions within the light exit surface 17b of the light guide plate 17. In short, the shape of the lens is determined to achieve the effect that the exit light from the single chip LED 22a and the exit light from the dual chip LED 22b can be diffused and mixed within the light guide plate 17, and thus the difference in the luminosity in the boundary between the center portion and the screen periphery portion of the image display screen becomes inconspicuous.

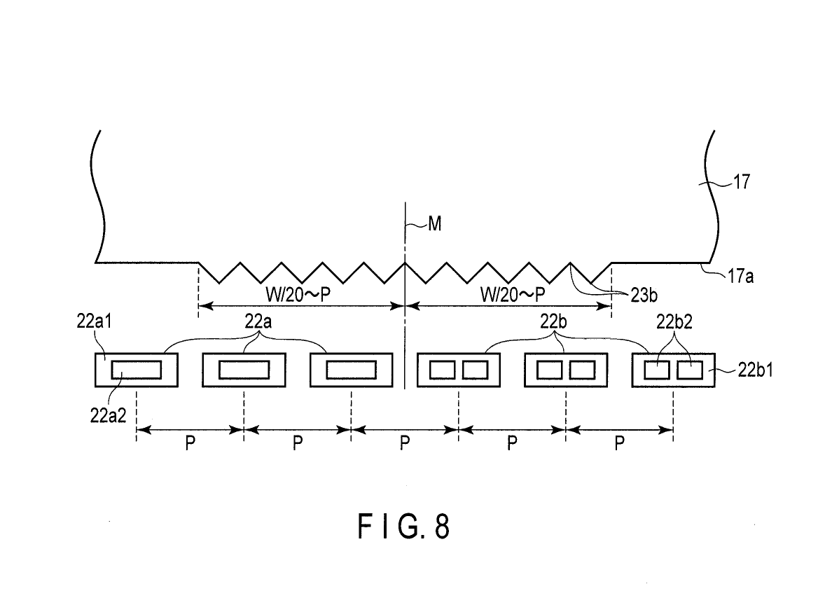

Alternatively, as illustrated in FIG. 8, a lens 23b having a mountain shape i.e., an inversed V shape or a groove shape i.e., a V shape is considered to be formed along a thickness direction of the light guide plate 17 in the portion corresponding to the vicinity of the boundary between the center portion and the screen periphery portion of the image display screen, i.e., in the portion corresponding to the position where the single chip LED 22a and the dual chip LED 22b adjoin, along the thickness direction of light guide plate 17, within the light incident surface 17a of the light guide plate 17. In this case, a repeat pitch of the lens 23b is considered to be about 25 μm, for example. Of course, the lens 23 may be formed in the light exit surface 17b of the light guide plate 17.

By having this configuration, the exit light from the single chip LED 22a and the exit light from the dual chip LED 22b are diffused and mixed with each other by the lens 23b and then the mixed light is incident onto the light guide plate 17. Accordingly, the difference in the luminosity in the boundary between the center portion and the screen periphery portion of the image display screen becomes inconspicuous. Thus, such an image display that a viewer may not feel unnaturalness throughout the whole screen is performed.

Moreover, the range of the portion, in which the lens 23b is formed, within the light incident surface 17a of the light guide plate 17 is considered, as described above, to be 5% (W/20) of the horizontal length W of the light guide plate 17 at most and to be the installation pitch P of the LEDs 22, 22, . . . at least in each of left and right sides of a central line M which orthogonally intersects the direction in which the LEDs 22, 22, . . . are arranged and which divides the pitch P between the single chip LED 22a and the dual chip LED 22b adjoining each other in half into a left portion and a right portion.

In order to make the difference in the luminosity in the boundary between the center portion and the screen periphery portion of the image display screen inconspicuous, it is effective to combine a technique of adjusting a distance between the light guide plate 17 and the LED bar 20, or a technique of performing taper rolling with respect to the light incident surface 17a of the light guide plate 17 in the thickness direction, etc. with the technique described with reference to FIGS. 6 through 8.

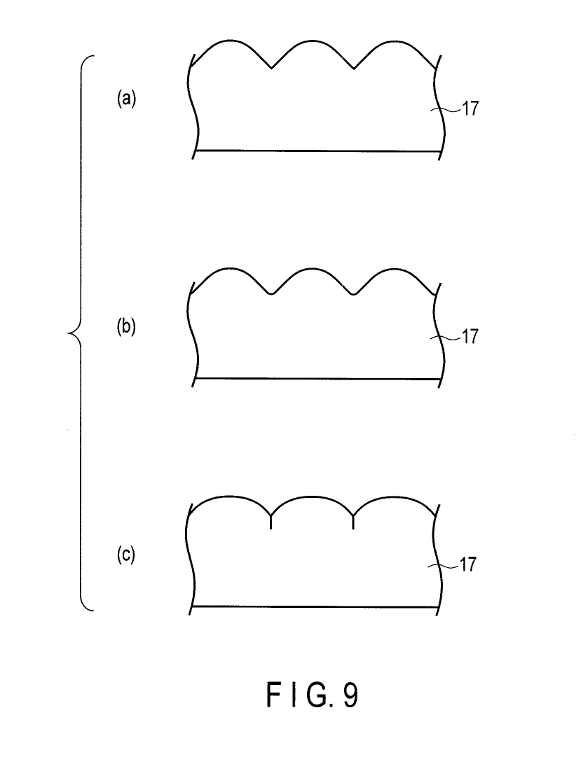

Although the mountain shape of an inversed V shape (or the groove shape of a V shape) is considered to be the shape of the lenses 23 and 23a formed in the light exit surface 17b of the light guide plate 17, or the shape of the lens 23b formed in the light incident surface 17a, the shape is not limited to these shape. For example, as illustrated in (a) of FIG. 9, an inversed V shape with a rounded top also may be considered. As illustrated in (b) of FIG. 9, both of the top of a mountain of a reversed V shape and the bottom of a groove of a V shape may be rounded. As illustrated in (c) of FIG. 9, a rectangular shape with rounded corners may be used. In short, as the lens 23, 23a, or 23b, various shapes can be used according to the range where light is guided. Furthermore, the shape is not limited to only one kind of shape, but it may be a mixture of various kinds of shapes.

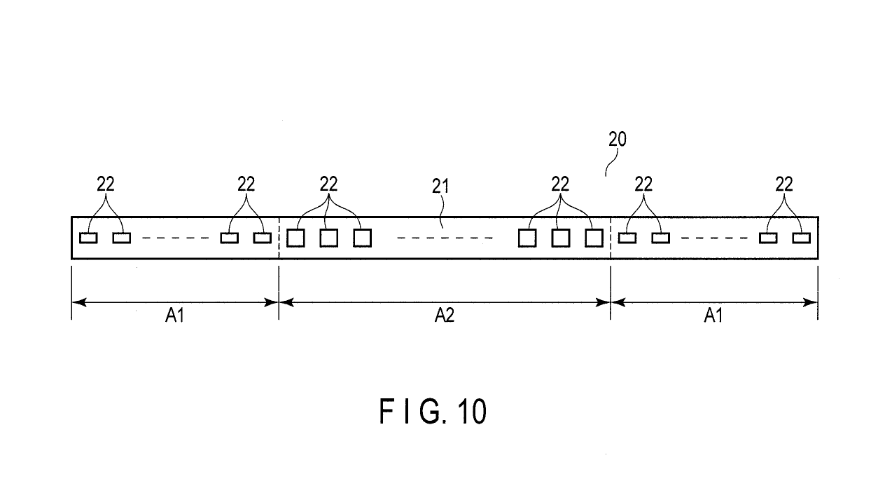

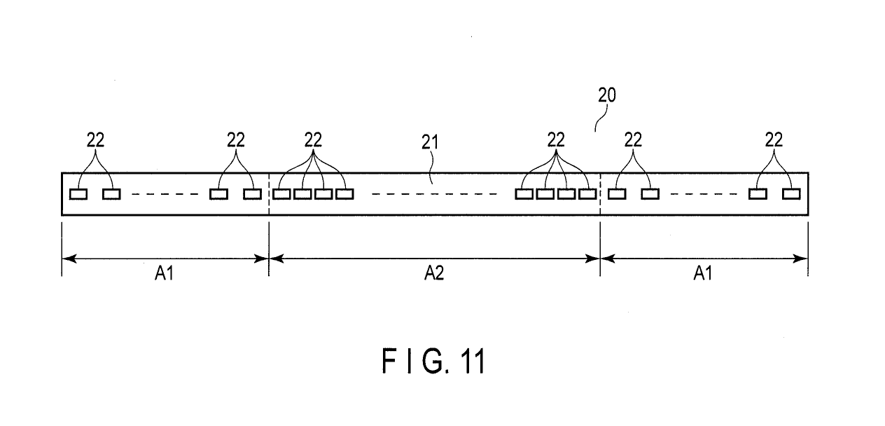

FIGS. 10 and 11 illustrate other examples of the unit configured to set the light quantity of the LEDs 22, 22, . . . which emit light to the center portion of the image display screen among the plurality of LEDs 22, 22, . . . which constitute the LED bar 20 to be larger than the light quantity of the LEDs 22, 22, . . . which emit light to the periphery portion of the image display screen.

That is, in the example illustrated in FIG. 10, the quantity of illumination light for the center portion of the image display screen is increased compared with the quantity of illumination light for the screen periphery portion of the image display screen by setting a chip area of the LEDs 22, 22, . . . installed in the region A2 of the LED bar 20 which corresponds to the center portion of the image display screen is set to be two times larger than a chip area of the LEDs 22, 22, . . . installed in the regions A1 and A1 of the LED bar 20 which correspond to the screen periphery portion of the image display screen.

Alternatively, in the example illustrated in FIG. 11, the quantity of illumination light for the center portion of the image display screen is increased compared with the quantity of illumination light for the screen periphery portion of the image display screen by setting a density of the LEDs 22, 22, . . . installed in the region A2 of the LED bar 20 which corresponds to the center portion of the image display screen to be two times higher than a density of the LEDs 22, 22, . . . installed in the regions A1 and A1 of the LED bar 20 which correspond to the screen periphery portion of the image display screen.

Further alternatively, the quantity of illumination light for the center portion of the image display screen can be also increased compared with the quantity of illumination light for the screen periphery portion of the image display screen by setting an amount of current flowing to the LEDs 22, 22, . . . installed in the region A2 of the LED bar 20 which corresponds to the center portion of the image display screen to be larger than an amount of current flowing to the LEDs 22, 22, . . . installed in the regions A1 and A1 of the LED bar 20 which correspond to the screen periphery portion of the image display screen.

Yet alternatively, the quantity of illumination light for the center portion of the image display screen can be also increased compared with the quantity of illumination light for the screen periphery portion of the image display screen by suitably combining the techniques described in FIGS. 3, 10 and 11 with the technique of changing the amount of current flowing to the LEDs 22, 22, . . . .

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An edge light-type back light unit configured to cause exit light from a light source to be incident onto a back surface of a liquid crystal display panel via a light guide plate, the back light unit comprising:
a light quantity controller configured to set a quantity of light emitted to a portion of the liquid crystal display panel which corresponds to a center portion of an image display screen to be larger than a quantity of light emitted to a portion of the liquid crystal display panel which corresponds to a periphery portion of the image display screen;
a lens of the light guide plate configured to prevent diffusion of the light exiting the light source and being incident onto a portion other than a portion corresponding to a vicinity of a boundary between the center portion and the periphery portion of the image display screen; and
a light diffuser of the light guide plate configured to diffuse light exiting the light source and being incident onto the portion corresponding to the vicinity of the border between the center portion and the periphery portion of the image display screen.

2. The back light unit of claim 1, wherein the light source includes a plurality of LEDs arranged along an end portion of the light guide plate, and
the light guide plate includes a plurality of lenses of a mountain shape or a groove shape, each extending in a direction orthogonally intersecting a direction in which the plurality of LEDs are arranged and being arranged at a predetermined repeat pitch along the direction in which the plurality of LEDs are arranged, within a portion other than the portion corresponding to the vicinity of the boundary between the center portion and the periphery portion of the image display screen.

3. The back light unit of claim 1, wherein a range of the light diffuser formed in the light guide plate is set to a range of 5% of a horizontal length of the light guide plate at most and an installation pitch of the plurality of LEDs at least in each of a left side and right side of a central line which is set to the boundary between the center portion and the periphery portion of the image display screen.

4. The back light unit of claim 2, wherein the light guide plate comprises the light diffuser configured to set a repeat pitch of the lens formed in the portion corresponding to the vicinity of the boundary between the center portion and the periphery portion of the image display screen to be longer than a repeat pitch of the lens formed in a portion other than the portion corresponding to the vicinity of the boundary between the center portion and the periphery portion of the image display screen.

5. The back light unit of claim 2, wherein the light guide plate comprises the light diffuser without the lens in the portion corresponding to the vicinity of the boundary between the center portion and the periphery portion of the image display screen.

6. The back light unit of claim 2, wherein the light guide plate comprises the light diffuser configured to set a vertical height of the lens formed in the portion corresponding to the vicinity of the boundary between the center portion and the periphery portion of the image display screen to be smaller than a vertical height of the lens formed in a portion other than the portion corresponding to the vicinity of the boundary between the center portion and the periphery portion of the image display screen.

7. The back light unit of claim 2, wherein the light guide plate comprises the light diffuser configured to diffuse incident light and provided in a portion of a light incident surface onto which the exit light from the plurality of LEDs is incident, the portion corresponding to the vicinity of the boundary between the center portion and the periphery portion of the image display screen.

8. A image display device comprising an edge light-type back light unit configured to cause exit light from a light source to be incident onto a back surface of a liquid crystal display panel via a light guide plate, the image display device comprising:
a light quantity controller configured to set a quantity of light emitted to a portion of the liquid crystal display panel which corresponds to a center portion of an image display screen to be larger than a quantity of light emitted to a portion of the liquid crystal display panel which corresponds to a periphery portion of the image display screen,
wherein the light guide plate comprises a lens configured to prevent diffusion of the light exiting the light source and being incident onto a portion other than a portion corresponding to a vicinity of a boundary between the center portion and the periphery portion of the image display screen, and a light diffuser configured to diffuse light exiting the light source and being incident onto the portion corresponding to the vicinity of the border between the center portion and the periphery portion of the image display screen.
